(19) United States
(12) Patent Application Publication
(10) Pub. No.: US 2011/0112802 A1
(43) Pub. Date: May 12, 2011

(54) System and Method For Visualizing Data Corresponding To Physical Objects

(76) Inventors: Brian D. Wilson, Humble, TX (US); Indra Datta, Houston, TX (US); Yao-Chou Cheng, Houston, TX (US); Timothy A. Chartrand, Spring, TX (US)

(21) Appl. No.: 12/871,598

(22) Filed: Aug. 30, 2010

Related U.S. Application Data
(60) Provisional application No. 61/260,664, filed on Nov. 12, 2009.

(51) Int. Cl. G06F 17/50; E21B 43/00

(52) U.S. Cl. 703/1; 166/369

(57) ABSTRACT

There is provided a system and method for providing a visualization of data corresponding to a physical structure, the data relating to a property that varies along a curved path. An exemplary method comprises defining the curved path by successively computing values for a position, a measured depth and an exit vector for a plurality of path points along the curved path. The exemplary method also comprises providing a visual representation corresponding to the data for the property.

### CROSS REFERENCE TO RELATED APPLICATION

This application claims the benefit of U.S. Provisional Patent Application 61/260,664 filed Nov. 12, 2009, entitled “System and Method for Visualizing Data Corresponding to Physical Objects,” the entirety of which is incorporated by reference herein.

### FIELD

The present techniques relate to providing visualizations of data corresponding to physical objects and analysis thereof In particular, an exemplary embodiment of the present techniques relates to determining a curved path that corresponds to a physical object and simultaneously providing visualizations of data corresponding to multiple user-selected properties of interest along the curved path, such as a well bore.

### BACKGROUND

This section is intended to introduce various aspects of the art, which may be associated with embodiments of the disclosed techniques. This discussion is believed to assist in providing a framework to facilitate a better understanding of particular aspects of the disclosed techniques. Accordingly, it should be understood that this section is to be read in this light, and not necessarily as admissions of prior art.

Many fields of study involve the analysis of data corresponding to properties of interest at various locations within physical structures. Examples of structures that can be subjected to 2D or 3D analysis include the earth's subsurface, facility designs and the human body, to name just three examples.

In the field of providing visualizations of the earth's subsurface, there exist multitudes of data that may be displayed along a well path, from geologic information about the subsurface properties the well is penetrating to hydrocarbon or fluid production information coming from a well. Determining an accurate representation of a well path in the subsurface, however, presents a complex problem.

Rendering the path of a well as a curve is not a well-defined problem, as the path geometry is not directly available and must be derived from available measured depth, inclination, and azimuth data. One known method of estimating a well path in the subsurface for the purpose of providing accurate visualizations of data employs a Hermite Polynomial fit. This method provides an estimate of the well path by beginning from a fully-defined initial point (one whose actual position, measured depth, and exit vector are known). The rest of the path is then calculated with only measured depth values or position data via an iterative process. Once the Hermite polynomial has been calculated, it can be used to provide a visual representation of well-related properties of interest along the curved path as well. Another known method of estimating a well path includes the use of cubic spline curve fitting.

Another related problem involves the positioning of data near an estimated well path in a way that reduces distortion of the data. A strip chart, also known as a well log in geologic applications, is one known method of visualizing data. Well logs define data for a region next to a well. Well logs inherently provide a two-dimensional visualization of data. For example, a typical well log shows a measurement value (actual or synthetic) of a property or parameter of interest and the corresponding depth. Displaying this data in a three-dimensional scene along a well path can lead to misleading distortions of this data, since well paths are generally displayed as line segments rather than the more realistic curved path. Distortions of the well log can occur along these paths, from compression along sections that should be curved to kinks at the endpoints of these segments. In order to more accurately display this data, methods are presented to render both the logs and the bore data via curves.

However, problems rendering log data in two-dimensional space may occur when the data is graphed along the curved well path. Limitations in the rendering space can result in misleading spacing of data points or distortions in the magnitude of the data.

A known method for reducing distortions is to render the log data in 3D. This may be done by rotating, or lathing, the log graph about the well path. This results in a cylinder of varying radius. Discretized rendering of these cylinders can be used to provide a disc-based log rendering, in which each different one of a plurality of discretized discs represents a region where a property of interest has a value that is the same or within an acceptable range.

U.S. Pat. No. 7,596,481 describes a visualization system for a wellbore environment. The disclosed system includes a graphics processor for creating a computer rendered visual model of a well, and optionally a drill string, based on data sets of depth-varying and/or time-varying parameters of the well. The model is then displayed on a graphics display. A user interface facilitates user navigation along the length of the well to any selected region therein, and further permits user adjustment of orientation of the displayed renderings as well as a temporal selection of the time-varying data to be displayed. Simulated, real, or a combination of simulated and real wellbore data, which may be steady state, transient, or real-time data, may be visually depicted at any selected region. This provides the user with a visual indication of the wellbore environment as the user navigates the visualization spatially and temporally.

Thus, numerous techniques exist for providing visualizations of data corresponding to various locations in a physical object or system. A system and method of providing an improved estimation of the actual location of a curved path such as a well path along which to display data, as well as reducing distortion in displayed data, is desirable.

### SUMMARY

An exemplary embodiment of the present techniques comprises a method for providing a visualization of data corresponding to a physical structure, the data relating to a property that varies along a curved path. The method comprises defining the curved path by successively computing values for a position, a measured depth and an exit vector for a plurality of path points along the curved path. The method also comprises providing a visual representation corresponding to the data for the property. The property may comprise a location of the curved path. The exit vector for each of the plurality of path points may be defined by an azimuth and an inclination.

An exemplary embodiment of the present technique may comprise defining an offset path that is offset by a fixed amount from the curved path. The fixed amount may be a fraction of a value of the property at a corresponding one of a plurality of display locations. Providing a visual representation may comprise providing a visual representation of the property at each of a plurality of display locations. The visual representation may be positioned between the segment of the curved path and the offset path.

Exemplary embodiments of the present techniques may comprise defining a plurality of display locations that comprise a plurality of points corresponding to values of the property. Each of the plurality of points may correspond to a product of a normal vector of the curved path and a data value of the property.

At least a portion of the curved path may be defined using a Hermite polynomial analysis. In addition, at least a portion of the curved path may be defined using a cubic spline analysis.

One exemplary embodiment of the present techniques relates to a computer system that is adapted to provide a visualization of data corresponding to a physical structure. The data may relate to a property that varies along a curved path. The computer system comprises a processor and a tangible, machine-readable storage medium that stores machine-readable instructions for execution by the processor. The machine-readable instructions comprise code that, when executed by the processor, is adapted to cause the processor to define the curved path by successively computing values for a position, a measured depth and an exit vector for a plurality of path points along the curved path. The machine-readable instructions also comprise code that, when executed by the processor, is adapted to cause the processor to provide a visual representation corresponding to data for the property along the curved path. The property may comprise a location of the curved path. The exit vector for each of the plurality of path points may be defined by an azimuth and an inclination.

An exemplary computer system may comprise code that, when executed by the processor, is adapted to cause the processor to define an offset path that is offset by a fixed amount from the curved path.

In one computer system, the fixed amount comprises a fraction of a value of the property at a corresponding one of a plurality of display locations. An exemplary computer system may comprise code that, when executed by the processor, is adapted to cause the processor to provide a visual representation of the property at each of a plurality of display locations. The visual representation may be positioned between the segment of the curved path and the offset path.

An exemplary computer system may comprise code that, when executed by the processor, is adapted to cause the processor to define a plurality of points corresponding to values of the property. Each of the plurality of points may correspond to a product of a normal vector of the curved path and a data value of the property.

One exemplary computer system comprises code that, when executed by the processor, is adapted to cause the processor to define at least a portion of the curved path using a Hermite polynomial analysis. In addition, an exemplary computer system may comprise code that, when executed by the processor, is adapted to cause the processor to define at least a portion of the curved path using a cubic spline analysis.

Another exemplary embodiment according to the present techniques relates to a method for producing hydrocarbons from an oil and/or gas field. The method comprises defining a curved path by successively computing values for a position, a measured depth and an exit vector for a plurality of path points along the curved path. The method also comprises providing a visual representation corresponding to a property that varies along the curved path. Hydrocarbons may be extracted from the oil and/or gas field using the visual representation. The property may comprise a location of the curved path. In one exemplary method of producing hydrocarbons, the exit vector for each of the plurality of path points is defined by an azimuth and an inclination.

### DESCRIPTION OF THE DRAWINGS

Advantages of the present techniques may become apparent upon reviewing the following detailed description and drawings of non-limiting examples of embodiments in which:

FIG. 1 is a 2D graph showing a representation of well log data displayed along a well bore using an offset path according to an exemplary embodiment of the present techniques;

FIG. 2 is a 2D graph showing a representation of well log data displayed along a well bore without the use of an offset path according to an exemplary embodiment of the present techniques;

FIG. 3 is a 2D graph showing a representation of well log data displayed along a well bore using a proportional offset path according to an exemplary embodiment of the present techniques;

FIG. 4 is a 3D graph showing a representation of well log data displayed as a plurality of cylinders rendered along a well bore according to an exemplary embodiment of the present techniques;

FIG. 5 is a 3D graph showing a representation of well log data displayed as a plurality of discretized discs along a well bore according to an exemplary embodiment of the present techniques;

FIG. 6 is a process flow diagram showing a method for providing a visualization of a curved path according to exemplary embodiments of the present techniques;

FIG. 7 is a process flow diagram showing a method for producing hydrocarbons from a subsurface region such as an oil and/or gas field according to exemplary embodiments of the present techniques; and

FIG. 8 is a block diagram of a computer network that may be used to perform a method for providing a visualization of a curved path according to exemplary embodiments of the present techniques.

### DETAILED DESCRIPTION

In the following detailed description section, specific embodiments are described in connection with preferred embodiments. However, to the extent that the following description is specific to a particular embodiment or a particular use, this is intended to be for exemplary purposes only and simply provides a description of the exemplary embodiments. Accordingly, the present techniques are not limited to embodiments described herein, but rather, it includes all alternatives, modifications, and equivalents falling within the spirit and scope of the appended claims.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent.

As used herein, the term “3D data volume” refers to a collection of data that describes a 3D object. An example of a 3D data volume that describes a portion of a subsurface region is a 3D seismic data volume.

As used herein, the term “3D seismic data volume” refers to a 3D data volume of discrete x-y-z or x-y-t data points, where x and y are not necessarily mutually orthogonal horizontal directions, z is the vertical direction, and t is two-way vertical seismic signal travel time. In subsurface models, these discrete data points are often represented by a set of contiguous hexahedrons known as cells or voxels. Each data point, cell, or voxel in a 3D seismic data volume typically has an assigned value (“data sample”) of a specific seismic data attribute such as seismic amplitude, acoustic impedance, or any other seismic data attribute that can be defined on a point-by-point basis.

As used herein, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and/or a computer. One or more computer components can reside within a process and/or thread of execution and a computer component can be localized on one computer and/or distributed between two or more computers.

As used herein, the terms “computer-readable medium” or “machine-readable medium” refer to any tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the present techniques are considered to include a tangible storage medium or distribution medium and prior art-recognized equivalents and successor media, in which the software implementations of the present techniques are stored.

As used herein, the term “azimuth” refers to an angular compass direction in degrees (for example, north=0, east=90) of an exit vector of a path point in the initial direction of travel to the next successive path point.

As used herein, the term “exit vector” refers to a unit vector that is tangent to the curved path where it intersects a path point, with a direction that is defined by a combined azimuth and an inclination, and located at the path point and directed along the path toward the next path point at a greater measured depth.

As used herein, the term “inclination” refers to an angular vertical direction in degrees (for example, straight down=0, horizontal=90) of an exit vector of a path point in the initial direction of travel to the next successive path point.

As used herein, the term “measured depth” refers to a length along a curved path such as a well path. Measured depth may be abbreviated as MD herein.

As used herein, the term “seismic data” refers to a multi-dimensional matrix or grid containing information about points in the subsurface structure of a field, where the information was obtained using seismic methods. Seismic data typically is represented using a structured grid. Seismic attributes or properties are cell- or voxel-based. Seismic data may be volume rendered with opacity or texture mapped on a surface.

As used herein, the term “simulation model” refers to a structured grid or an unstructured grid with collections of points, faces and cells.

As used herein, the term “horizon” refers to a geologic boundary in the subsurface structures that are deemed important by an interpreter. Marking these boundaries is done by interpreters when interpreting seismic volumes by drawing lines on a seismic section. Each line represents the presence of an interpreted surface at that location. An interpretation project typically generates several dozen and sometimes hundreds of horizons. Horizons may be rendered using different colors so that they stand out in a 3D visualization of data.

As used herein, the term “position” refers to a specific location in x,y,z space. A plurality of positions may define a curved path such as a path of a well bore in the subsurface.

As used herein, the terms “property” or “property of interest” refer to a user-defined property for which data may be displayed along a curved path. Examples of properties of interest in the geologic field include porosity, volume of shale, volume of sand, reservoir zone/subzone, oil production rate, gas production rate, water production rate, total volume produced, core size, casing size, temperature, or the like.

As used herein, the term “stacking” is a process in which traces (i.e., seismic data recorded from a single channel of a seismic survey) are added together from different records to reduce noise and improve overall data quality. Characteristics of seismic data (e.g., time, frequency, depth) derived from stacked data are referred to as “post-stack” but are referred to as “pre-stack” if derived from unstacked data. More particularly, the seismic data set is referred to being in the pre-stack seismic domain if unstacked and in the post-stack seismic domain if stacked. The seismic data set can exist in both domains simultaneously in different copies.

As used herein, the terms “visualization engine” or “VE” refer to a computer component that is adapted to present a model and/or visualization of data that represents one or more physical objects.

Some portions of the detailed description which follows are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions using the terms such as “defining”, “selecting”, “displaying”, “limiting”, “processing”, “computing”, “obtaining”, “predicting”, “producing”, “providing”, “updating”, “comparing”, “determining”, “adjusting” or the like, refer to the action and processes of a computer system, or similar electronic computing device, that transforms data represented as physical (electronic) quantities within the computer system's registers and memories into other data similarly represented as physical quantities within the computer system memories or registers or other such information storage, transmission or display devices. Example methods may be better appreciated with reference to flow diagrams.

While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various serially occurring actions, it is to be appreciated that various actions could occur concurrently, substantially in parallel, and/or at substantially different points in time.

As set forth below, exemplary embodiments of the present techniques relate to providing intuitive and understandable visual representations of data along a curved path. More specifically, exemplary embodiments relate to the provision of an accurate estimate of a curved path such as a well path in the subsurface.

An exemplary embodiment of the present techniques relates to a visualization engine or VE that is adapted to support rendering of visualizations of data. Moreover, a VE according to the present techniques relates to creating a visualization of a curved path. Properties of interest may be shown along the curved path in 2D or 3D space while reducing distortion. Data that may be visualized according to an exemplary embodiment of the present techniques include a wide range of geologic or engineering data, such as a 3D data volume, stacked or unstacked seismic data (including a 3D seismic data volume), simulation model data, horizon data or the like, to name just a few examples.

Exemplary embodiments of the present techniques relate to providing 2D well log graphs displayed along a curved path with reduced distortion. In one exemplary embodiment, a curved path corresponding to a well path is determined One edge of the well log graph follows the well path, with the placement of the data point calculated from the product of the normal vector of the well path and the magnitude of the data at the log position. This method results in the edge of the well log rendering closer to the well path showing minimal distortion at the expense of greater distortion of points near the edge further away. These distortions may be reduced using exemplary embodiments of the present techniques, as set forth below.

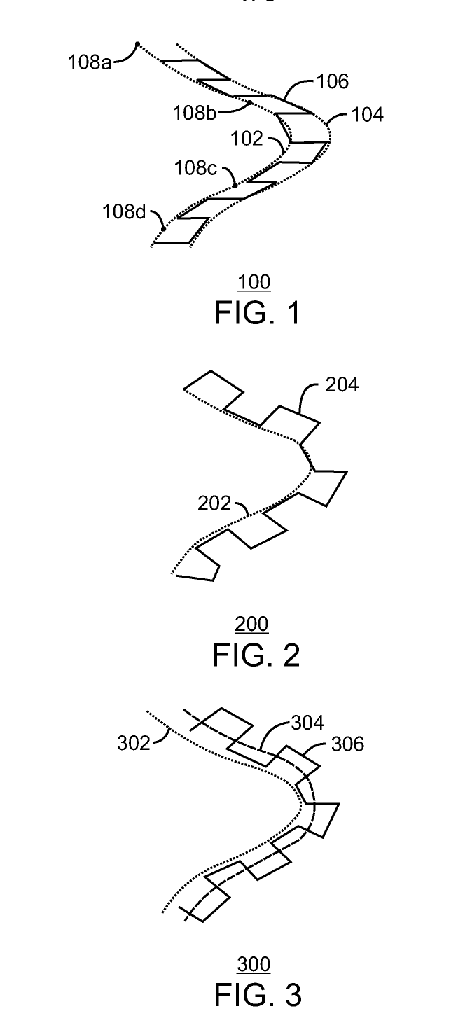

FIG. 1 is a 2D graph showing a representation of well log data displayed along a well bore using an offset path according to an exemplary embodiment of the present techniques. The graph is generally referred to by the reference number 100. The graph 100 shows a well path curve 102, which represents the path of a well bore in the subsurface. According to an exemplary embodiment of the present techniques, the well path curve 102 is defined by a plurality of path points 108a, 108b, 108c and 108d. The determination of the path points that define the well path curve 102 according to exemplary embodiments of the present techniques is explained in detail herein.

A path point on the well path curve 102 may be said to be fully defined if the following properties are known: position, measured depth and exit vector (azimuth and inclination). Frequently, only the first path point in a well path (for example, the initial path point 108a in FIG. 1) is fully defined. The remaining path points are generally only partially defined, with a subset of the above properties known at each path point through logging measurements, for example. In the most common cases, the only information that is known at each path point is the position of the point or the change in measured depth to the point along with its exit vector.

Exemplary embodiments of the present techniques provide a method for iteratively filling in the missing information for each well path point, given that the first point is fully defined, in such a way that realistic curvature is introduced between them. For each iteration, the calculated information for the previous path point allows that point to be considered to be fully defined so that the missing information for the next successive path point may be determined.

In the relatively simple cases where the exit vector from the previous path point is aimed directly at the current point with known position, a straight-line path segment is implied. Frequently, however, the change in measured depth between the previous path point and current path point may be determined to be greater than the change in position, in which case it is inferred that the path segment between these two path points is not a straight line, but rather a curved path that is longer than the change in position. Because no further information is provided, the actual curvature is unknown, but it can be reasonably estimated using a curved path.

In an exemplary embodiment of the present technique, a curved path that may mathematically be allowed to span between the two points within the constraints of known exit vectors is determined This determination may be made using a number of techniques, such as Hermite polynomial analysis or cubic spline analysis, to name just two examples. Because of the need to maintain realistic data, sometimes both the position and the measured depth for known well path points may be “over-specified” in such a way that it is not possible to create a curved path that spans between two known path points and obeys the constraint on the exit vector leaving the previous point.

Once a curved well path such as the well path curve 102 has been calculated according to an exemplary embodiment of the present technique, a visual representation of the curved path may be used in a variety of ways. For example, the curved path may be rendered with a VE in conjunction with visual representations of data corresponding to properties of interest along the well path. Examples of methods of providing visual representations of data in conjunction with the well path curve 102 are described in detail herein. In addition, the curved path may be used in algorithms involving other subsurface data and objects.

In general, path points such as the path points 108a, 108b, 108c and 108d that define the well path curve 102 have specific properties. For example, a successive path point is determined using an (x,y,z) location of the previous path point as a starting point. The measured depth of the path point is the total length along the path up to that point. The azimuth of a path point is an angular compass direction in degrees of a direction of travel (an exit direction) to the next successive path point. The inclination of the path point is an angular vertical direction in degrees of the direction of travel (the exit direction) to the next successive path point. A path point may be referred to as fully specified if all of these properties have known values. If there are any values missing, the path point may be referred to as partially specified.

To calculate values for a next successive path point, the previous path point is assumed to be above or prior to the next path point to be determined The next path point to be determined may be referred to herein as the “current” path point. The previous path point is fully specified with position, measured depth, azimuth, and inclination. The data needed to fully specify the previous path point may have been observed or determined by calculation in a previous iteration (i.e., when the previous path point was the current path point). Additionally, the previous path point is known to have a measured depth less than that of the current path point. The data for the previous path point is not changed by the calculation to determine the current path point.

The current path point is defined to be the path point just below or after the previous path point. The current path point has (or will have, after calculation) a measured depth greater than the previous path point. At the beginning of the calculation, the current path point is only partially specified, with the unknown properties to be determined by the calculation. When the calculation is complete, the current path point will then be fully specified with all property values.

The calculation of the current path point may employ certain derived properties. For example, a 3D unit vector with a direction that is the same as the combined azimuth and inclination may be used. In addition, an MD difference equal to the positive difference between an MD value at the current path point and an MD value at the previous path point may also be used.

The following symbols may be used to describe the calculation of the fully specified values for the current path point, in accordance with an exemplary embodiment of the present techniques:
Pₙ₋₁=position of the previous path point
Vₙ₋₁=exit vector (azimuth and inclination) of the previous path point
MDₙ₋₁=measured depth at the previous path point
Pₙ=position of the current path point
Vₙ=exit vector (azimuth and inclination) of the current path point
MDₙ=measured depth at the current path point
ΔP=distance between Pₙ₋₁and Pₙ
ΔMD=MD difference (current MD-previous MD)

According to an exemplary embodiment of the present techniques, the following conditions may be applied to the calculation of the position of the current path point:
Pₙ₋₁ can be any position
Vₙ₋₁ is a unit vector, for which the calculation relates to its direction and not its magnitude
If MDₙ, is not specified, then MDₙ₋₁ can be any non-negative value
If MDₙ is specified, it must be greater than MDₙ₋₁
If Pₙ is specified, it can be any position
If Vₙ is specified, it must be a unit vector, for which the calculation relates to its direction and not its magnitude (unit vector)

The relationship between ΔMD and ΔP may be used as a basis of the calculation of the position of the current path point. Such a calculation may be based on an assumption that ΔMD≧ΔP because the difference in measured depth cannot be less than the straight-line (shortest) distance between the two path points. Moreover, the calculation of the position of the current path point becomes trivial if the path between the previous path point and the current path point is a straight line. Specifically, if the calculation input is such that Vₙ₋₁ at Pₙ₋₁ is aimed directly at a specified Pₙ, then a straight-line path segment is implied. The trivial calculation of the position of the current path point reduces to the following:
Vₙ=Vₙ₋₁
ΔMD=ΔP
Pₙ=Pₙ₋₁+(ΔMD*Vₙ₋₁)

If ΔMD>ΔP, then it may be inferred that the path segment between these two path points is not in a straight line, but rather a curved path that is longer than ΔP. Because no further information is provided, the actual curvature is unknown, but it can be reasonably estimated using a curved path. As noted herein, methods of defining curved segments according to exemplary embodiments of the present techniques include Hermite polynomial analysis, cubic spline analysis or the like.

According to an exemplary embodiment of the present techniques, the path points that define the well path curve 102 are determined by iteratively identifying curved paths that define segments between path points. In this manner, path points along the well path curve 102 may be fully specified by determining P, MD, and/or V at each path point. Because the calculation depends on the previous point being fully specified, it follows that the first point in the path is fully specified with all properties to begin the iteration to solve the entire path.

In addition to providing a method of determining the well path curve 102, exemplary embodiments of the present techniques relate to reducing distortion when displaying visual representations of data corresponding to properties of interest along the well path curve 102. In one such method of reducing distortion, the well path curve 102 is offset by a fixed amount in a direction orthogonal to the vector pointing towards a camera and a vector between the first and last points of the well path. An offset path curve 104 represents the fixed offset relative to the well path curve 102. Data corresponding to a property of interest is drawn between the well path curve 102 and the offset path curve 104 to help reduce distortion. In FIG. 1, the data corresponding to the property of interest is represented by a trace 106. Moreover, the trace 106 represents the value of the property of interest at a corresponding place along the well curve path 102.

In a visualization according to exemplary embodiments of the present techniques, additional properties of interest may be displayed. For example, the trace 106 may vary in shade of color or amount of color to represent additional properties of interest. In addition, the thickness or stipple of the trace 106 may vary to represent additional properties of interest. Other visual aspects of the trace 106 may be varied to represent still more properties of interest. Further examples include varying the amount of transparency of the trace 106, or its reflectivity and/or specular highlight.

Also, the fact of whether any value (visual representation) of the trace 106 is displayed at all may be used to convey information about a property of interest. For instance, the presence of the trace 106 over a portion of the well path curve 102 may indicate some type of geologic area of interest or may reflect an engineering aspect of a well, such as a perforation. The absence of the trace 106 over a portion of the well path curve 102 may indicate that the corresponding region is not of particular geologic interest or may indicate the absence of an engineering characteristic, such as a perforation.

The visualization method shown in FIG. 1 results in a low likelihood that the trace 106 will be drawn over itself, even in concave sections. Nonetheless, the visualization method shown in FIG. 1 results in varying distortions depending on how close the orientation of the section being drawn is to the offset path curve 104.

FIG. 2 is a 2D graph showing a representation of well log data displayed along a well bore without the use of an offset path according to an exemplary embodiment of the present techniques. The graph is generally referred to by the reference number 200. The graph 200 shows a well path curve 202, which represents the path of a well bore in the subsurface. The well path curve 202 may be determined by successively computing values for individual path points (not shown in FIG. 2), as set forth herein.

Data corresponding to a property of interest is represented by a trace 204. In the exemplary visualization method shown in FIG. 2, one edge of the trace 204 is defined to follow the well path curve 202, with the placement of the point representing the data value calculated from the product of the normal vector of the well path and the magnitude of the data at the log position. This method results in the edge of the trace 204 being positioned closer to the well path curve 202 showing minimal distortion at the expense of greater distortion of the edge further away.

FIG. 3 is a 2D graph showing a representation of well log data displayed along a well bore using a proportional offset path according to an exemplary embodiment of the present techniques. The graph is generally referred to by the reference number 300. The visualization method shown in FIG. 3 combines elements of the visualization methods shown in FIGS. 1 and 2.

The graph 300 shows a well path curve 302, which represents the path of a well bore in the subsurface. The well path curve 302 may be determined by successively computing values for individual path points (not shown in FIG. 3), as set forth herein. An offset path curve 304 is created at a distance half the width of the desired well log rendering at locations normal to the original curve. The offset path curve 304 may be positioned in the direction orthogonal to the well path curve 302 vectors pointing towards the camera and the one between the first and last points of the well path curve 302.

Data corresponding to a property of interest is drawn as a trace 306. Portions of the trace 306 may be rendered on either side of the offset path curve 304, and normal to it. This results in a mitigation of the distortions of the rendering by splitting the distortion among both sides of the log rendering. In the visualization method shown in FIG. 3, the placement of the offset path curve 304 results in a more pinched shape in concave sections and a more expanded one in convex sections of the trace 306.

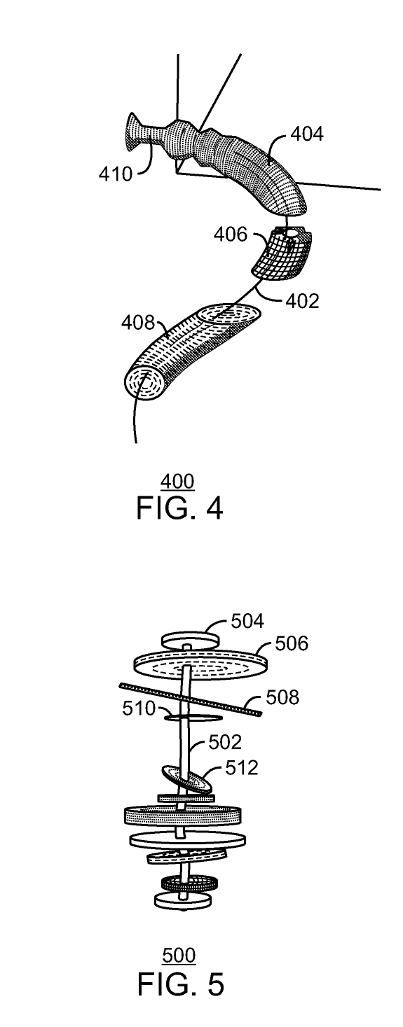

FIG. 4 is a 3D graph showing a representation of well log data displayed as a plurality of cylinders rendered along a well bore according to an exemplary embodiment of the present techniques. The graph is generally referred to by the reference number 400. The graph 400 shows a well path curve 402, which represents the path of a well bore in the subsurface. The well path curve 402 may be determined by successively computing values for individual path points (not shown in FIG. 4), as set forth herein. The graph 400 shows how continuous disc regions may be used to depict multiple data parameters in an intuitive and informative way.

A first region or cylinder 404 shows values indicative of one or more properties of interest. In FIG. 4, the first region 404 is shown as a cylinder or continuous disc of varying radius. The first region 404 may comprise a surface of revolution centered along the well path curve 402. The x,y,z location of the first region 404 in 3D space may be based on a measured depth of a corresponding point along the well path curve 402. In accordance with an exemplary embodiment of the present techniques, the first region 404 may be texture mapped, such that a picture of an actual well bore taken with a downhole camera, pictures of core samples or other images can be displayed in conjunction with or on the well path curve 402. The first region 404 may also comprise an integer property that is displayed as a number of sides on a geometric shape.

A value of a first property of interest in the first region 404 is shown by varying the radius of the 3D depiction of the first region 404 along the well path curve 402. For example, the relatively small radius of the first region 404 at the location indicated by an arrow 410 indicates a relatively low value of the first property of interest for the corresponding portion of the well path curve 402.

According to an exemplary embodiment of the present techniques, additional properties of interest may be depicted for the first region 404. For example, values of additional properties of interest may be depicted in the first region 404 by varying the shade or amount of color of the depiction of the first region 404 in a 3D display. Different shades or amounts of color may correspond to different values of other properties of interest. For example, differing degrees of red may be used to reflect differing values of one property of interest and differing degrees of green and blue may reflect differing values of other properties of interest. In this manner, data corresponding to a relatively large number of properties of interest may be displayed simultaneously for particular points along the well path curve 402.

A second region or cylinder 406, which is depicted as a cylinder or continuous disc of varying radius in FIG. 4, may show values for multiple properties of interest along the well path curve 402. For example, one or more of the shade of color, the amount of color or the radius of the second region 406 may vary to show differing values for different properties of interest.

In an exemplary embodiment of the present techniques, the presence or absence of a property of interest may be shown by the presence or absence of a graphical representation at a particular point along the well path curve 402. For example, the lack of a graphical representation between the first region 404 and the second region 406 may indicate that a particular property of interest has no value in that region along the well path curve 402. Alternatively, the absence of a visual representation between the first region 404 and the second region 406 may indicate the absence of a specified geologic or engineering condition, such as a perforation, in the corresponding portion of the well path curve 402.

A third region or cylinder 408, which is depicted as a cylinder or continuous disc of varying radius in FIG. 4, may also show values for multiple properties of interest along the well path curve 402. For example, one or more of the shade of color, the amount of color or the radius of the third region 408 may vary to show differing values for differing properties of interest.

In addition to varying the radii, the shade of color or the amount of color of a rendering in the first region 404, the second region 406 or the third region 408, other techniques may be used to provide information about additional properties of interest along the well path curve 402. For example, a varying degree of transparency of an object rendered in the region may be used to indicate a value of a property of interest. In addition, the reflectivity and/or specular highlight of an object rendered in a region may vary to indicate varying values of additional properties of interest.

In accordance with an exemplary embodiment of the present techniques, regions where perforations exist in a well casing may be shown along the well path curve 402. In such a situation, values for properties of interest may be shown only in regions where perforations exist.

FIG. 5 is a 3D graph showing a representation of well log data displayed as a plurality of discretized discs along a well bore according to an exemplary embodiment of the present techniques. The graph is generally referred to by the reference number 500. The graph 500 shows a well path curve 502, which represents the path of a well bore in the subsurface. The well path curve 502 may be determined by successively computing values for individual path points (not shown in FIG. 5), as set forth herein. The graph 500 shows how a plurality of discretized discs may be used to display multiple data parameters in an intuitive and informative way.

Each discretized disc represents values of one or more properties of interest for a particular region of the well path curve 502. For example, a first disc 504 represents values for one or more properties of interest at a corresponding region of the well path curve 502. A second disc 506 represents values for one or more properties of interest at a corresponding region of the well path curve 502. Similarly, a third disc 508, a fourth disc 510 and a fifth disc 512 each represents values for one or more properties of interest at corresponding regions of the well path curve 502. As with the continuous disc regions shown in FIG. 4, the plurality of discretized discs shown in FIG. 5 may each employ a wide variety of techniques to depict values for properties of interest. For example, the discretized discs may vary in radius to show variance in a first property of interest. Differing shades or amounts of color may show variations in additional properties of interest. Also, varying degrees of transparency, reflectivity and/or specular highlight may show variations in values of additional properties of interest.

In one exemplary embodiment, the radius of the discretized discs may represent different properties of interest by not remaining constant in all directions. Moreover, the radius may represent different properties shown on different axes. For example, the fourth disc 510 has varying radii along the x-axis. In this manner, a value for a first property of interest may be displayed on a positive x-axis and a value for another property of interest may be displayed on a negative x-axis. Similarly, a value for a first property of interest may be displayed on a positive y-axis and a value for another property of interest may be displayed on a negative y-axis. Moreover, a first property may be rendered on the left side of a well path and a second property may be rendered on the right side of the well path, such that they stay on the left and right sides when the model is rotated. This method of visualization may be described as employing positive and negative axes in screen space rather than in model space.

If sufficient space is present between the discretized discs shown in FIG. 5, the thickness of the discretized discs may be varied according to the value of an additional property of interest. Additional properties of interest may be represented by varying the thickness around a disc at −x, +x, −y and/or +y locations. Also, the degree of tilt of the discretized discs with respect to the well path curve 502 may vary according to the value of yet another property of interest. Additional properties of interest may be shown by varying the tilt of a disc with respect to other axes, such as a minor axis.

An exemplary embodiment of the present techniques allows a user to identify regions along a well path that meet very specific criteria regarding a relatively large number of properties of interest. For example, the user could inspect a visualization created in accordance with the present techniques in search of a portion along a well path rendered as a particular color corresponding to a first property of interest, a particular degree of shininess corresponding to a second property of interest, and so on. Other physical characteristics of the rendering that may correspond to additional properties of interest include disc radius and thickness, reflectivity, transparency or tilt. Moreover, the number of faces rendered to build the surface of the disc can be reduced to create non-round, multi-sided shapes (for example, triangular, square, hexagonal or the like), and these shapes may indicate still another property of interest. Thus, exemplary embodiments of the present technique allow data from a relatively large number of well logs to be readily observed in a single intuitive visualization.

According to an exemplary embodiment of the present techniques, still more properties of interest may be displayed by rendering a colored strip chart alongside of a disc portion or discretized discs, as described herein. Alternatively, a single log could be created to represent a product of data values corresponding to some properties of interest divided by data values corresponding to other properties of interest.

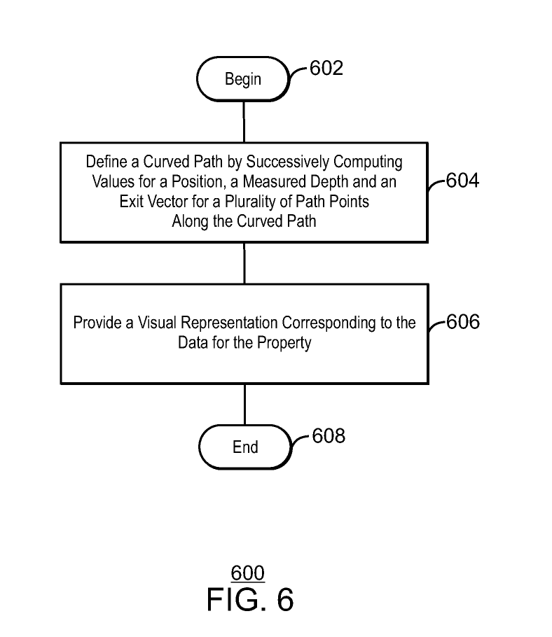

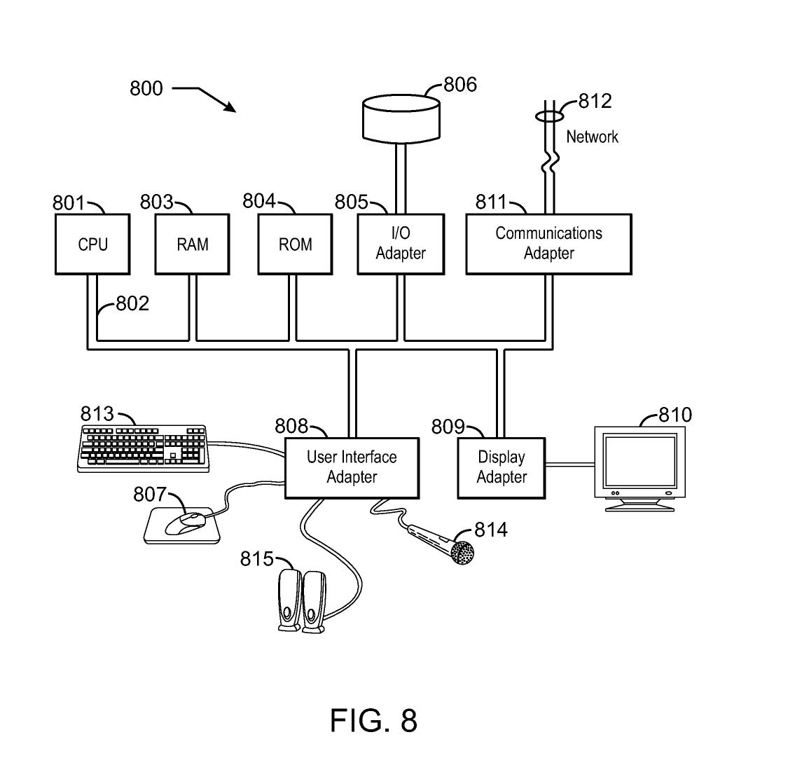

FIG. 6 is a process flow diagram showing a method for providing a visualization of data corresponding to a physical structure according to an exemplary embodiment of the present techniques. The process is generally referred to by the reference number 600. The data relates to a property that varies along a curved path, such as the path of a hydrocarbon-producing well drilled in a subsurface region. The process 600 may be executed using one or more computer components of the type described below with reference to FIG. 8. Such computer components may comprise one or more tangible, machine-readable media that stores computer-executable instructions. The process 600 begins at block 602.

At block 604, a curved path is defined by successively computing values for a position, a measured depth and an exit vector for a plurality of path points along the curved path. As shown at block 606, a visual representation corresponding to the data for the property is provided. The process ends at block 608.

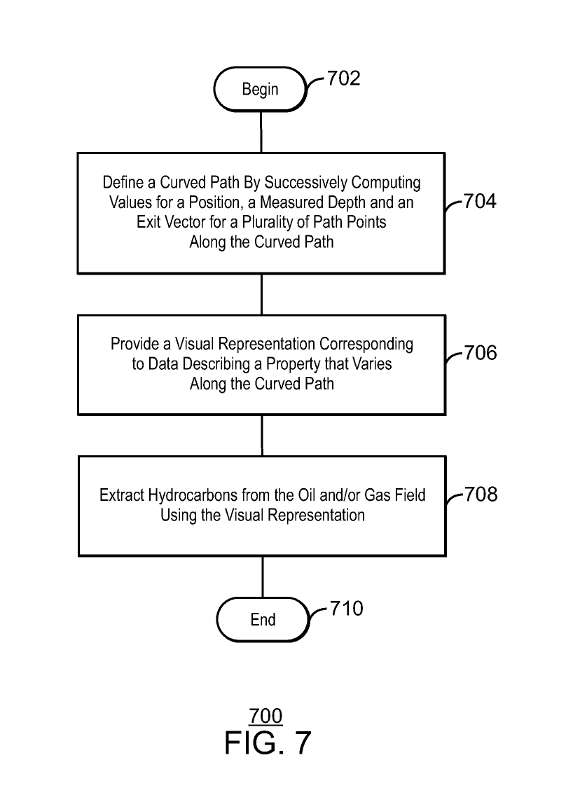

FIG. 7 is a process flow diagram showing a method for producing hydrocarbons from a subsurface region such as an oil and/or gas field according to exemplary embodiments of the present techniques. The process is generally referred to by the reference number 700. Those of ordinary skill in the art will appreciate that the present techniques may facilitate the production of hydrocarbons by producing visualizations that allow geologists, engineers and the like to determine a course of action to take to enhance hydrocarbon production from a subsurface region. By way of example, a visualization produced according to an exemplary embodiment of the present techniques may allow an engineer or geologist to determine a well placement to increase production of hydrocarbons from a subsurface region. At block 702, the process begins.

At block 704, a curved path corresponding to a well path in an oil and/or gas field is defined by successively computing values for a position, a measured depth and an exit vector for a plurality of path points along the curved path. At block 706, a visual representation corresponding to a data value of a property that varies along the curved path is provided. As explained herein, the abilities to provide an accurate representation of the curved path and to display data about a relatively large number of properties of interest that may affect hydrocarbon production allows improved efficiency in producing hydrocarbons in the oil and/or gas field.

At block 708, hydrocarbons are extracted from the oil and/or gas field using the visual representation. The process ends at block 710.

FIG. 8 is a block diagram of a computer network that may be used to perform a method for providing visualizations of data that represents a physical object according to exemplary embodiments of the present techniques. The computer network is generally referred to by the reference number 800.

A central processing unit (CPU) 801 is coupled to system bus 802. The CPU 801 may be any general-purpose CPU, although other types of architectures of CPU 801 (or other components of exemplary system 800) may be used as long as CPU 801 (and other components of system 800) supports the inventive operations as described herein. The CPU 801 may execute the various logical instructions according to various exemplary embodiments. For example, the CPU 801 may execute machine-level instructions for performing processing according to the operational flow described above in conjunction with FIG. 6 or FIG. 7.

The computer system 800 may also include computer components such as a random access memory (RAM) 803, which may be SRAM, DRAM, SDRAM, or the like. The computer system 800 may also include read-only memory (ROM) 804, which may be PROM, EPROM, EEPROM, or the like. RAM 803 and ROM 804 hold user and system data and programs, as is known in the art. The computer system 800 may also include an input/output (I/O) adapter 805, a communications adapter 811, a user interface adapter 808, and a display adapter 809. The I/O adapter 805, the user interface adapter 808, and/or communications adapter 811 may, in certain embodiments, enable a user to interact with computer system 800 in order to input information.

The I/O adapter 805 preferably connects a storage device(s) 806, such as one or more of hard drive, compact disc (CD) drive, floppy disk drive, tape drive, etc. to computer system 800. The storage device(s) may be used when RAM 803 is insufficient for the memory requirements associated with storing data for operations of embodiments of the present techniques. The data storage of the computer system 800 may be used for storing information and/or other data used or generated as disclosed herein. The communications adapter 811 may couple the computer system 800 to a network 812, which may enable information to be input to and/or output from system 800 via the network 812 (for example, the Internet or other wide-area network, a local-area network, a public or private switched telephony network, a wireless network, any combination of the foregoing). User interface adapter 808 couples user input devices, such as a keyboard 813, a pointing device 807, and a microphone 814 and/or output devices, such as a speaker(s) 815 to the computer system 800. The display adapter 809 is driven by the CPU 801 to control the display on a display device 810 to, for example, display information or a representation pertaining to a portion of a subsurface region under analysis, such as displaying a curved path and associated data that varies along the curved path, according to certain exemplary embodiments.

The architecture of system 800 may be varied as desired. For example, any suitable processor-based device may be used, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may use any number of suitable structures capable of executing logical operations according to the embodiments.

The present techniques may be susceptible to various modifications and alternative forms, and the exemplary embodiments discussed above have been shown only by way of example. However, the present techniques are not intended to be limited to the particular embodiments disclosed herein. Indeed, the present techniques include all alternatives, modifications, and equivalents falling within the spirit and scope of the appended claims.

What is claimed is:

1. A method for providing a visualization of data corresponding to a physical structure, the data relating to a property that varies along a curved path, the method comprising:
defining the curved path by successively computing values for a position, a measured depth and an exit vector for a plurality of path points along the curved path; and
providing a visual representation corresponding to the data for the property.

2. The method recited in claim 1, wherein the property comprises a location of the curved path.

3. The method recited in claim 1, wherein the exit vector for each of the plurality of path points is defined by an azimuth and an inclination.

4. The method recited in claim 1, comprising defining an offset path that is offset by a fixed amount from the curved path.

5. The method recited in claim 4, wherein the fixed amount is a fraction of a value of the property at a corresponding one of a plurality of display locations.

6. The method recited in claim 4, wherein providing a visual representation comprises providing a visual representation of the property at each of a plurality of display locations, the visual representation being positioned between the segment of the curved path and the offset path.

7. The method recited in claim 1, comprising defining a plurality of display locations that include points corresponding to values of the property.

8. The method recited in claim 1, comprising defining at least a portion of the curved path using a Hermite polynomial analysis.

9. The method recited in claim 1, comprising defining at least a portion of the curved path using a cubic spline analysis.

10. A computer system that is adapted to provide a visualization of data corresponding to a physical structure, the data relating to a property that varies along a curved path, the computer system comprising:
a processor; and
a tangible, machine-readable storage medium that stores machine-readable instructions for execution by the processor, the machine-readable instructions comprising:
code that, when executed by the processor, is adapted to cause the processor to define the curved path by successively computing values for a position, a measured depth and an exit vector for a plurality of path points along the curved path; and
code that, when executed by the processor, is adapted to cause the processor to provide a visual representation corresponding to the data for the property along the curved path.

11. The computer system recited in claim 10, wherein the property comprises a location of the curved path.

12. The computer system recited in claim 10, wherein the exit vector for each of the plurality of path points is defined by an azimuth and an inclination.

13. The computer system recited in claim 10, comprising code that, when executed by the processor, is adapted to cause the processor to define an offset path that is offset by a fixed amount from the curved path.

14. The computer system recited in claim 13, wherein the fixed amount is a fraction of a value of the property at a corresponding one of a plurality of display locations.

15. The computer system recited in claim 13, comprising code that, when executed by the processor, is adapted to cause the processor to provide a visual representation of the property at each of a plurality of display locations, the visual representation being positioned between the segment of the curved path and the offset path.

16. The computer system recited in claim 10, comprising code that, when executed by the processor, is adapted to cause the processor to define a plurality of points corresponding to values of the property, each of the plurality of points corresponding to a product of a normal vector of the curved path and a data value of the property.

17. The computer system recited in claim 10, comprising code that, when executed by the processor, is adapted to cause the processor to define at least a portion of the curved path using a Hermite polynomial analysis.

18. The computer system recited in claim 11, comprising code that, when executed by the processor, is adapted to cause the processor to define at least a portion of the curved path using a cubic spline analysis.

19. A method for producing hydrocarbons from an oil and/or gas field, the method comprising:
defining a curved path by successively computing values for a position, a measured depth and an exit vector for a plurality of path points along the curved path;
providing a visual representation corresponding to data describing a property that varies along the curved path; and
extracting hydrocarbons from the oil and/or gas field using the visual representation.

20. The method recited in claim 19, wherein the property comprises a location of the curved path.
